(19) United States
(12) Patent Application Publication
(10) Pub. No.: US 2021/0301972 A1
(43) Pub. Date: Sep. 30, 2021

(54) CARRIER PLATE WITH ROLLABLE BALL THEREIN

(71) Applicant: SHIH-HUI HSING, Taipei City (TW)

(72) Inventor: SHIH-HUI HSING, Taipei City (TW)

(21) Appl. No.: 16/827,724

(22) Filed: Mar. 24, 2020

(51) Int. Cl. F16M 7/00; F16M 5/00; F16C 31/04

(52) U.S. Cl. CPC F16M 7/00; F16C 31/04; F16M 5/00

(57) ABSTRACT

A carrier plate with rollable balls therein comprises a plate body including an upper plate and a lower plate; the lower plate being fixed to a lower side of the upper plate; the upper plate and lower plate having a plurality of through holes which are positioned corresponding to the through holes of the upper plate; a plurality of balls loosely embedded into the through holes of the upper plate and the lower plate. A diameter of the ball is larger than the summation of widths of the upper plate and lower plate, and the balls protrude from an upper side of the upper plate and a lower side of the lower plate.

### FIELD OF THE INVENTION

The invention is related to carrier plates, and in particular to carrier plate with rollable ball.

### BACKGROUND OF THE INVENTION

Generally, in some factories, such as chemical factories, tobacco factories, etc., many heavy machines are equipped, which have weights of several tones, even several tens tons. In equipping or installation, it needs special technologies for moving these machines.

In many applications, it is necessary to fine adjust or horizontally move heavy machines or even they are needed to move vertically, while this is a very complicated and heavy works in conventional working ways and must be performed by special technologies. Therefore, it is time wasted, large costs and needs many labors for completing the works.

### SUMMARY OF THE INVENTION

Accordingly, for improving above mentioned defects in the prior art, the object of the invention is to provide a carrier plate with rollable ball therein. The invention serves to place a heavy object on the balls in the plate body. The weight of the heavy object may be several tens tons. If it is necessary to fine-adjust the location of the heavy object, since in the invention, the balls are on the upper side of the heavy object with balls therein, and thus the heavy object may be moved slightly with a slight force. Furthermore, a plurality of plate bodies are arranged on the four corners of the heavy object. Therefore, only slight force is used to move the heavy object, while the conventional way cannot achieve this object.

### BRIEF DESCRIPTION OF THE DRAWINGS

FIG. 1 is an assembled schematic view about the elements of the invention.

FIG. 2 is an elevational schematic view showing the bottom side of the invention.

FIG. 3 is an exploded schematic view about the elements of the invention.

FIG. 4 is a schematic view showing that a bottom plate is arranged to the invention.

FIG. 5 is a schematic view showing that a top plate is arranged to the invention.

FIG. 6 is a schematic view showing the application of the invention.

FIG. 7 is a schematic view showing that a jack is arranged on the plate body of the invention.

### DETAILED DESCRIPTION OF THE INVENTION

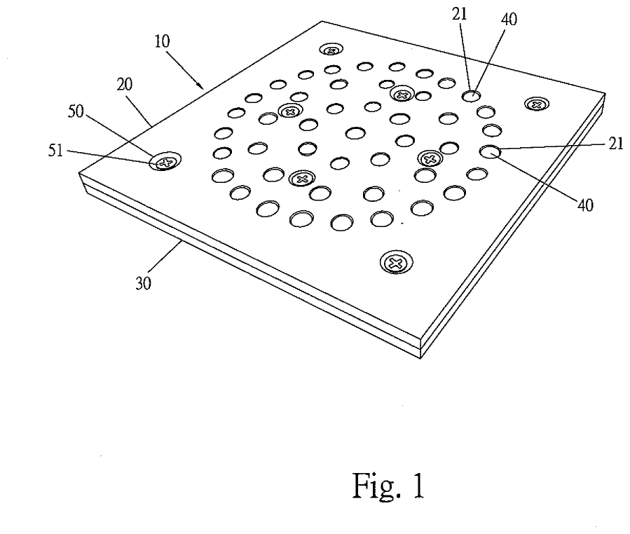

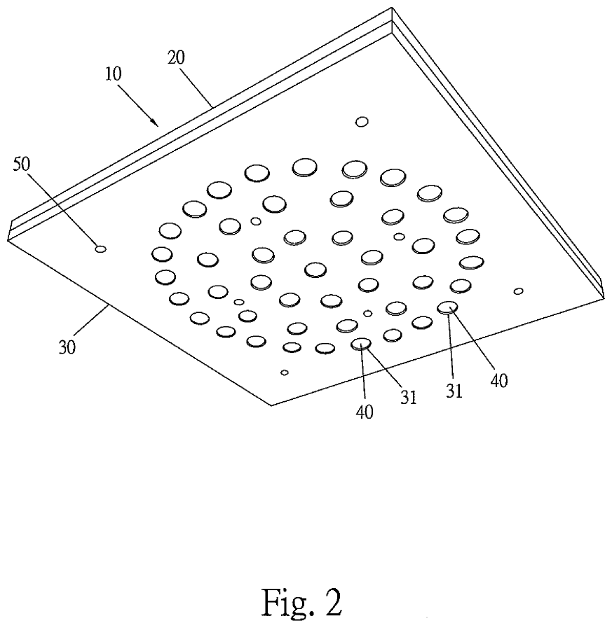

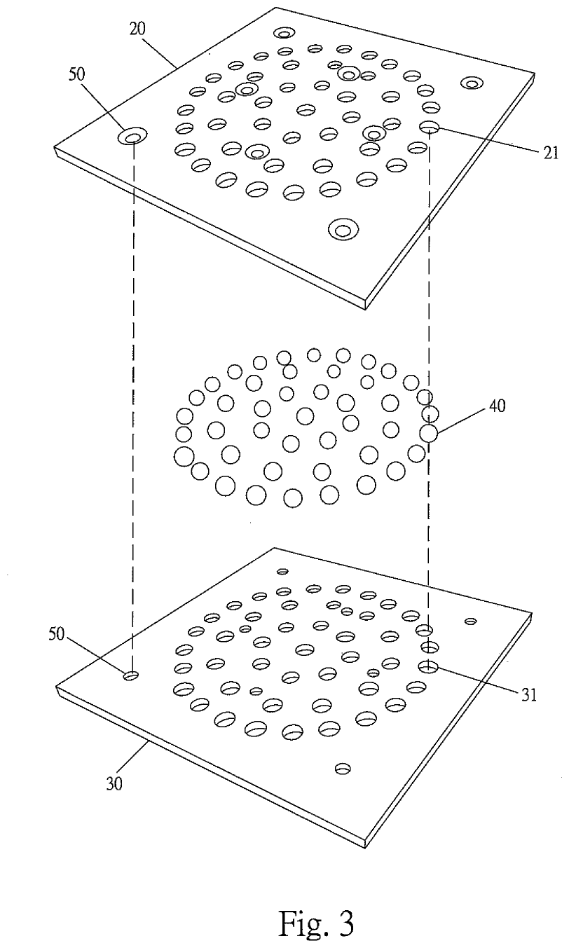

With reference to FIGS. 1 to 7, the carrier for rolling balls of the invention is illustrated. The invention includes the following elements.

A plate body 10 includes an upper plate 20 and a lower plate 30. The upper plate 20 is formed with a plurality of through holes 21. The lower plate 30 is fixed to a lower side of the upper plate 20 and has a shape corresponding to that of the upper plate 20. The lower plate 30 has a plurality of through holes 31 which are positioned corresponding to the through holes 21 of the upper plate 20.

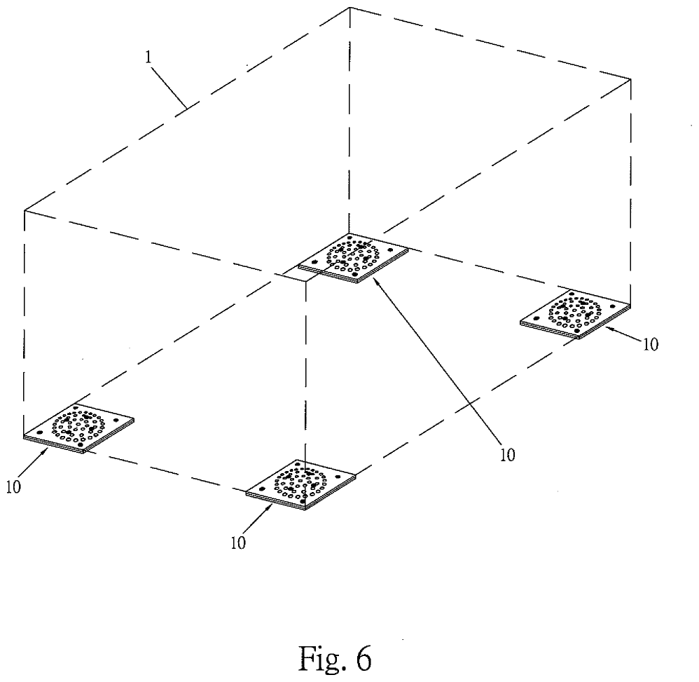

A plurality of balls 40 are loosely embedded into the through holes 21, 31 of the upper plate 20 and the lower plate 30. One of through holes 21 of the upper plate 20 and a corresponding one of the through holes 31 of the lower plate 30 are located with a respect one of the balls 40. The balls 40 are rotatable within the through holes. A diameter of the ball 30 is larger than the summation of a width of the upper plate 20 and a width of the lower plate 30, and an upper end of the ball 40 protrudes from an upper side of the upper plate 20, and a lower end of the ball 40 also protrudes from a lower side of the lower plate 30. Therefore, when the plate body 10 is placed on a surface, it is rollable along the surface. As illustrated in FIG. 6, if a plurality of heavy objects 1 are placed on the plate body 10, the balls 40 will support the heavy objects 1 and thus the heavy objects I are slidable along the balls 40.

In the invention, the balls 40, the upper plate 20 and the lower plate 30 are made of steel.

The number and sizes of the balls 40 are adjustable based on the objects supported thereby.

In the invention, the forms of the upper plate 20 and lower plate 30 may be different. In FIGS. 1 to 3, the upper plate 20 and lower plate 30 have rectangular shapes. However, this shape is not used to confine the scope of the invention, they may have other shapes, such as triangular shapes, round shapes, etc. All these shapes are within the scope of the invention. The upper plate 20 and lower plate 30 are formed with locking holes 50 for receiving screws 51 so as to fix the upper plate 20 to the lower plate 30. The ways for fixing the upper plate 20 with the lower plate 30 are not confined to above said. All other ways which could fix the upper plate 20 with the lower plate 30 are within the scope of the invention.

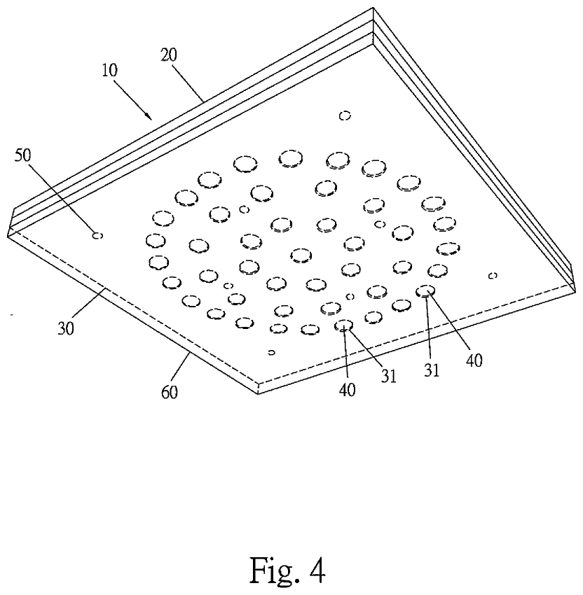

With reference to FIG. 4, the invention further comprises a bottom plate 60 which has a smooth upper surface and is located below the lower plate 30. If the lower plate 30 is placed on a coarse surface. The bottom plate 60 will contact the coarse surface so that the bottom plate 60 may roll on the bottom plate 60 for preventing the bottom plate 60 from motionlessness on the coarse surface. The bottom plate 60 may be a steel plate.

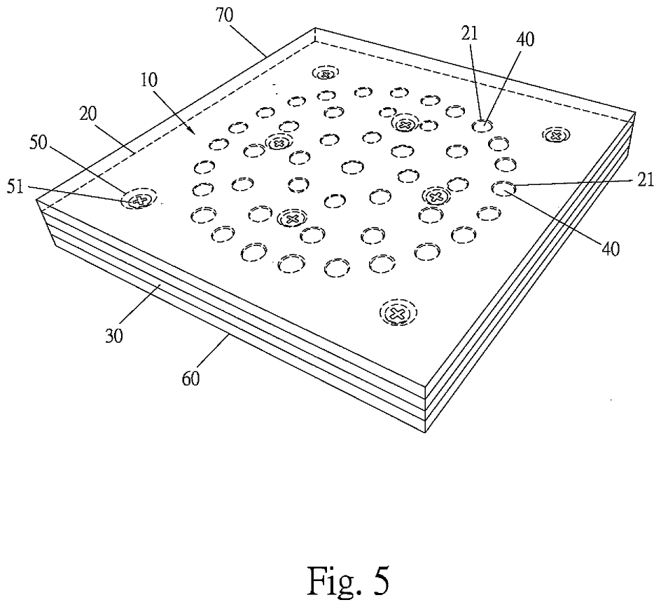

Referring to FIG. 5, the invention further comprises a top plate 70 which has a smooth upper surface. When a heavy object is placed on the top plate, the heavy object may be steadily located on the plate body 10. The top plate may be a steel plate.

The invention serves to place a heavy object on the balls 40 in the plate body 10. The weight of the heavy object may be several tens tons. If it is necessary to fine-adjust the location of the heavy object, since in the invention, the balls 40 are on the lower side of the heavy object, and thus the heavy object may be moved slightly with a slight force. Referring to FIG. 6, a plurality of plate bodies 10 are arranged on the four corners of the heavy object 1. Therefore, only slight force is used to move the heavy object, while the conventional way cannot achieve this object.

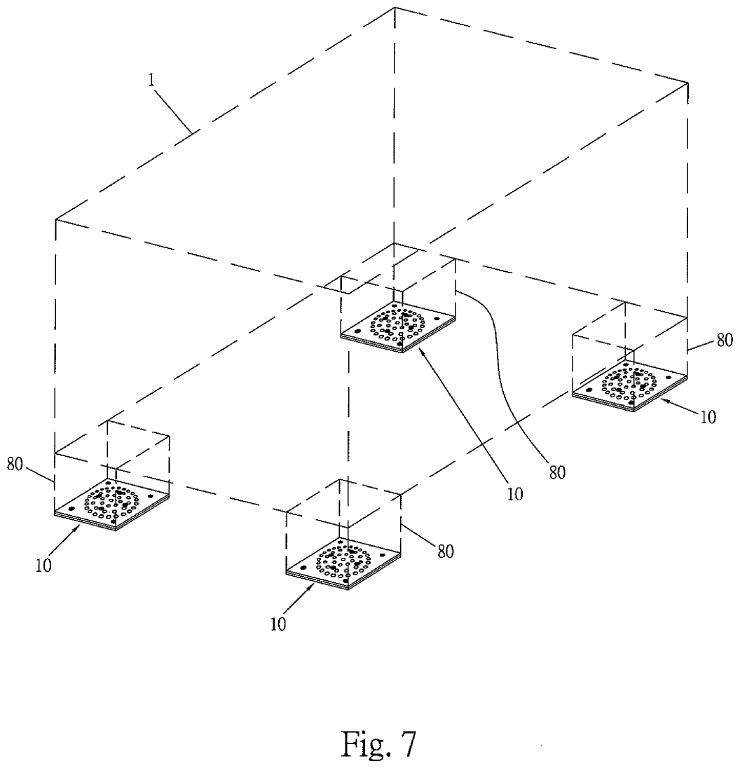

With reference to FIG. 7, a jack 80 is arranged on the upper side of the plate body 10 for supporting a heavy object 1. The jack 1 may lift or descent the heavy object 1, while the plate body 10 may horizontally move the heavy object 1 so that the object can be deposited 3 dimensionally.

The invention is thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A carrier plate with rollable balls therein, comprising:
a plate body including an upper plate and a lower plate; the upper plate being formed with a plurality of through holes; the lower plate being fixed to a lower side of the upper plate; the lower plate having a plurality of through holes which are positioned corresponding to the through holes of the upper plate;
a plurality of balls loosely embedded into the through holes of the upper plate and the lower plate; one of through holes of the upper plate and a corresponding one of the through holes of the lower plate being located with a respect one of the balls; the balls being rotatable within the through holes; a diameter of the ball being larger than the summation of a width of the upper plate and a width of the lower plate, and an upper end of the ball protruding from an upper side of the upper plate, and a lower end of the ball also protruding from a lower side of the lower plate.

2. The carrier plate with rollable ball therein, wherein the balls, the upper plate and the lower plate are made of steel.

3. The carrier plate with rollable ball therein as claimed in claim 1, wherein a number and sizes of the balls are adjustable based on the objects supported thereby.

4. The carrier plate with rollable ball therein as claimed in claim 1, wherein the upper plate and lower plate have rectangular shapes.

5. The carrier plate with rollable ball therein as claimed in claim 1, wherein the balls are arranged as concentric circles.

6. The carrier plate with rollable ball therein as claimed in claim 1, wherein the upper plate and the lower plate are formed with locking holes for receiving screws so as to fix the upper plate to the lower plate.

7. The carrier plate with rollable ball therein as claimed in claim 1, further comprising a bottom plate which has a smooth upper surface and is located below the lower plate.

8. The carrier plate with rollable ball therein as claimed in claim 7, wherein the bottom plate is made of steel.

9. The carrier plate with rollable ball therein as claimed in claim 1, further comprising a top plate which has a smooth upper surface.

10. The carrier plate with rollable ball therein as claimed in claim 9, wherein the top plate is made of steel.

11. The carrier plate with rollable ball therein as claimed in claim 1, wherein a jack is arranged on the upper side of the plate body for supporting a heavy object.
